(19) United States
(12) Patent Application Publication
(10) Pub. No.: US 2005/0207777 A1
(43) Pub. Date: Sep. 22, 2005

(54) Image forming apparatus

(75) Inventors: Katsunori Takahashi, Tokyo (JP); Tadashi Matsudaira, Tokyo (JP); Hiroshi Oyama, Tokyo (JP); Masayuki Watanabe, Tokyo (JP); Shinpei Kawasaki, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Business Technologies, Inc., Tokyo (JP)

(21) Appl. No.: 10/949,177

(22) Filed: Sep. 24, 2004

(30) Foreign Application Priority Data
Mar. 16, 2004 (JP) 2004-073729

(51) Int. Cl. G03G 15/00

(52) U.S. Cl. 399/88

(57) ABSTRACT

An image forming apparatus includes: an image reading section for obtaining image data by reading an image from a document; an image forming section for forming the image on a sheet based on the image data; a reception section for accepting a user operation regarding use of the image forming apparatus; and a whole control section for controlling an operation of the image reading section and an operation of the image forming section, wherein the image forming apparatus has a normal mode under which an operation of the image forming apparatus is provided, and a power saving mode under which electric power consumption of the image forming apparatus is reduced, and the whole control section is in a non-operating state under the power saving mode, and the whole control section is set to be in an operating state when the reception section accepts the user operation.

### BACKGROUND OF THE INVENTION

1. Field of the Invention

The invention relates to an image forming apparatus which forms an image on a sheet, for example, according to electrophotography.

2. Description of Related Art

What is well known is an image forming apparatus according to electrophotography, such as a digital copying machine or the like, which forms a latent image by irradiating light over a photosensitive layer of an evenly-charged photoreceptor, develops an image by making toner adhere to the photosensitive layer, and forms an image by transferring the toner to a sheet (transfer paper).

In such an image forming apparatus according to electrophotography, for example, large amount of electric power is consumed by a fixing device which is used for fixing the image on paper during an image formation. Therefore, conventionally, if a predetermined time period during which the image forming apparatus is not being used has passed, temperature of the fixing device is controlled to be lower than temperature necessary for the image formation by predetermined temperature, in order to reduce electric power consumption. The above-mentioned method is called a power saving mode.

In JP-Tokukaihei-9-163044A, disclosed is an invention regarding a copying machine system which performs such power saving by shutting off a power supply to a predetermined circuit, the invention being capable of suppressing troubles due to the inability of performing normal operations to the minimum, by heighten a possibility of performing the normal operations even if a failure occurs to a circuit for outputting a control signal for operating a power shutoff circuit which shuts the power off.

However, the image forming apparatus having such conventional power saving mode has the following problems.

That is, in an image forming apparatus these days, according to its high functionality, in addition to the fixing device for the image formation, the number of circuits that consume electric power at an unignorable level has been increasing.

However, in the conventional image forming apparatus, operations, controls, and influences to the other circuits regarding each circuit of the image forming apparatus under the power saving are not considered. Therefore, under the power saving mode of the conventional image forming apparatus, it is not possible to realize the power saving that is optimal and more effective for the image forming apparatus.

Further, in the copying machine system of the above-mentioned disclosed invention, operations under the power saving mode regarding each circuit thereof are not considered, and therefore the power saving is not sufficient.

### SUMMARY OF THE INVENTION

The present invention was made in view of the aforementioned problem, and an object of the present invention is to provide an image forming apparatus which is capable of reducing even more electric power consumption under a power saving mode.

In order to achieve the above-mentioned object, in accordance with a first aspect of the present invention, an image forming apparatus comprises: an image reading section for obtaining image data by reading an image from a document; an image forming section for forming an image on a sheet based on the image data; a reception section for accepting a user operation regarding use of the image forming apparatus; and a whole control section for controlling an operation of the image reading section and an operation of the image forming section, wherein the image forming apparatus has a normal mode under which an operation of the image forming apparatus can be provided, and a power saving mode under which electric power consumption of the image forming apparatus is reduced, and wherein the whole control section is in a non-operating state under the power saving mode, and is set to be in an operating state when the reception section accepts the user operation.

Preferably, the apparatus of the first aspect further comprises: an electric power shutoff section for putting the whole control unit in the non-operating state by shutting off an electric power supply to the whole control unit, wherein the electric power shutoff section shuts off the electric power supply to the whole control unit based on a first shutoff signal from the whole control section and a second shutoff signal from the reception section when both the first shutoff signal and the second shutoff signal indicate shutoff.

Preferably, in the apparatus of the first aspect, the reception section accepts the user operation under the power saving mode and returns the image forming apparatus to the normal mode.

Preferably, in the apparatus of the first aspect, when the reception section accepts the user operation under the power saving mode, the reception section switches the second shutoff signal to a signal indicating that electric power is supplied.

Preferably, in the apparatus of the first aspect, after the image forming apparatus is shifted to the power saving mode from the normal mode and the reception section receives a power down signal from the whole control section, the reception section accepts the user operation.

Preferably, in the apparatus of the first aspect, the reception section switches the second shutoff signal to a signal indicating shutoff only based on a command from the whole control section.

In accordance with a second aspect of the present invention, an image forming apparatus comprises: an image reading section for obtaining image data by reading an image from a document; an image forming section for forming an image on a sheet based on the image data; and a whole control section for controlling an operation of the image reading section and an operation of the image forming section, wherein a mode of the image forming apparatus is switchable between a normal mode under which an operation of the image forming apparatus can be provided and a power saving mode under which electric power consumption of the image forming apparatus is reduced, and the image forming apparatus performs switching of the whole control unit from an operating state to a non-operating state when being shifted to the power saving mode from the normal mode, and image forming apparatus is not returned to the normal mode from the power saving mode until the switching is completed.

Preferably, the apparatus of the second aspect further comprises an electric power shutoff section for putting the whole control section in the non-operating state by shutting off an electric power supply to the whole control section.

Preferably, the apparatus of the second aspect further comprising a reception section for accepting a user operation regarding use of the image forming apparatus, wherein, under the power saving mode, the reception section accepts the user operation and returns the image forming apparatus to the normal mode.

Preferably, the apparatus of the second aspect detects a return trigger for returning from the power saving mode to the normal mode after the switching is completed.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a sectional view showing a schematic structure of an image forming apparatus according to an embodiment of the present invention,

FIG. 2 is a block diagram showing a structure relating to a control of the image forming apparatus 100 shown in FIG. 1,

FIG. 3 is a flowchart illustrating a processing operation by the CPU 121 provided in the operation displaying control unit 102, which is carried out when the image forming apparatus 100 is shifted to a power saving mode,

FIG. 4 is a flowchart illustrating a processing operation by the CPU 104 provided in the whole control unit 101, which is carried out when the image forming apparatus 100 is shifted to the power saving mode, and

FIG. 5 is a flowchart illustrating a processing operation, which is carried out when the image forming apparatus 100 is returned to a normal mode from the power-saving mode.

### PREFERRED EMBODIMENTS OF THE INVENTION

Hereinafter, an embodiment of the present invention will be described with reference to figures.

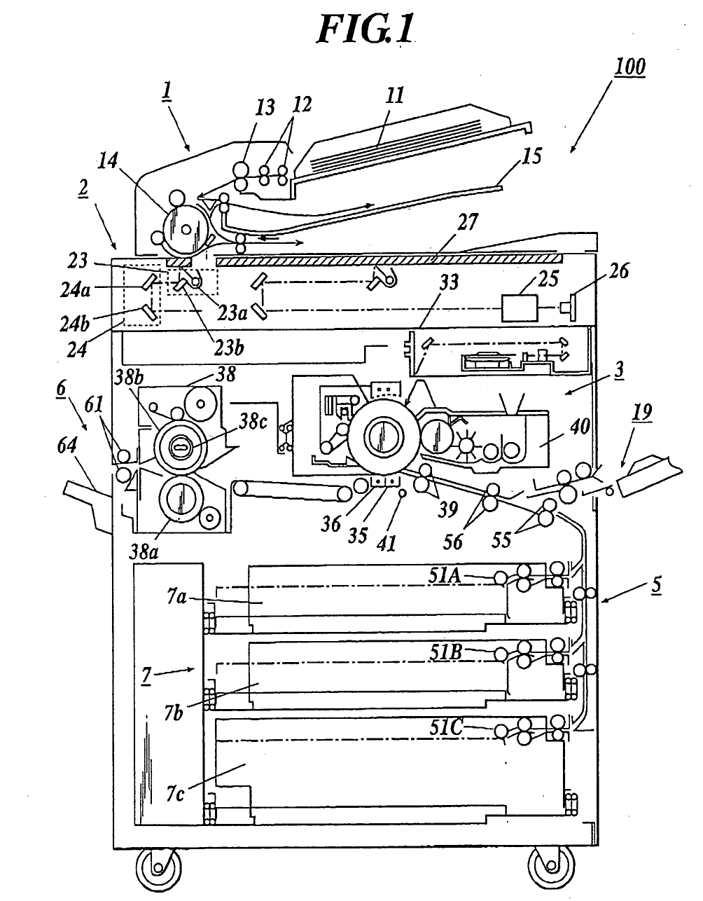

FIG. 1 is a sectional view showing a schematic structure of an image forming apparatus according to an embodiment of the present invention.

Here, a structure of an image forming apparatus and a fundamental operation of the same will be described with reference to FIG. 1.

When a user operates an operation displaying unit (it will be described later) provided in the image forming apparatus 100 to input an instruction of copying, a document put on a document feeding platform 11 of an automatic document feeding unit 1 so as to make an image surface thereof face upward is sent out one sheet after one sheet according to the movement of a sending-out roller 12. Then, after once being stopped for aligning the leading edges thereof by a registration roller 13, the document is conveyed to a conveyance drum 14. Then, the document is moved along a surface of the conveyance drum 14 while being contacted with the drum surface. Then, while the conveyance drum 14 is rotating counterclockwise direction, an image reading unit 2 performs the reading of the image. Thereafter, the rotation approximately as much as semicircle is done, and then the document is separated from the drum surface to be outputted to a sheet outputting platform 15. Further, in the case of reading both the sides, after the reading at one side is done, the document is flipped over. Then, the conveyance drum 14 re-conveys and the back side of the document is read.

The image reading unit 2 comprises a first mirror unit 23 comprising a light source 23a and a mirror 23b, a second mirror unit 24, provided orthogonal to a moving direction of the document, the second mirror unit 24 comprising a mirror 24a and a mirror 24b, an imaging lens 25 and a linear image pickup device 26. In the image reading unit 2, just below the conveyance drum 14, the light source 23a sequentially irradiates light over the passing documents, and the reflected light from the document image is reflected by the mirrors 23b, 24a and 24b. Then, the reflected light by the mirrors is focused through the imaging lens 25 toward the image pickup device 26 to obtain image information. Further, this image forming apparatus 100 has a function to perform the reading by moving the mirror units 23 and 24 while the document is put on a stationary document platform 27.

An image processing device applies an image processing on the image information of the document image which is read by the image reading unit 2, and the processed information is temporarily stored in a memory.

In the image forming unit 3, the image information is read out from the memory and inputted to an exposing device 33. Then, a laser emitting device (not shown) emits a laser beam which is modulated according to the image information so as to expose a photoconductor drum 31 having a photosensitive layer in a main scanning direction by rotating a polygon mirror. Thereby, the main scan is performed in the axial direction of the photoconductor drum 31 to which a charging device 32 in advance gives electric charge potential, and the sub scan is performed according to the rotation of the photoconductor drum 31, for forming an electrostatic latent image in the photosensitive layer of the photoconductor drum 31. Thereafter, a developing device 40 reversally develops the electrostatic latent image into a toner image with developer.

In parallel with the above-described process, a manual sheet feeding tray 19 or a main body sheet feeding tray 7, each being used as a sheet feeding device 5, feeds a sheet on which an image is to be formed. For example, the main body sheet feeding tray 7 comprises three levels of trays 7a, 7b and 7c, and when one of sheet feeding rollers 51A, 51B and 51C is activated to convey a sheet, the sheet is fed to a conveyance roller 55, a registration roller 56 and a conveyance roller 39. Then, the sheet is fed to the photoconductor drum 31 to be synchronized with the toner image on the photo conductor drum 31.

The photoconductor drum 31, while the sheet is on the surface of the photoconductor drum 31, receives discharge from a transferring device 35 and receives light irradiation from a discharging lamp (TSL) 41, and thereby the toner image on the photoconductor drum 31 is transferred to the sheet side. Then, the sheet on which the toner image is transferred is neutralized and separated from the photoconductor drum 31, and is conveyed to the fixing device 38 via a conveyance belt. Then, when the sheet passes between a fixing roller 38b which is heated by a heater 38c provided therewith and a fixing roller 38a, the sheet is heated and pressured, and thereby the toner is fixed. Then, the sheet is outputted from a fixed-sheet outputting roller 61 of an outputting unit 6, to the outputting tray 64.

Meanwhile, after the sheet is separated from the photoconductor drum 31 and the electric change is removed, a cleaning device 37 removes the residual toner from the photoconductor drum 31 to clean it, and the image forming apparatus 100 goes to a next image forming process.

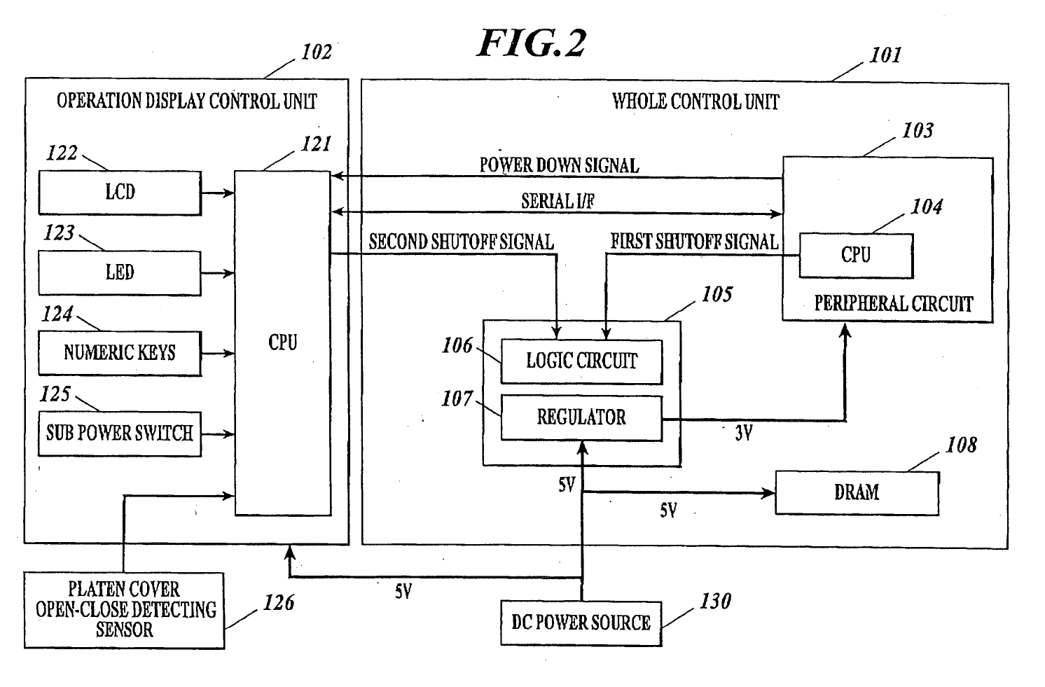

Here, each control as described above is performed by the CPU 104 provided in the whole control unit 101 shown in FIG. 2. On the other hand, when a user operates the image forming apparatus 100, an operation input is done on an operation displaying unit (will be described later) which is provided in the image forming apparatus 100. Controls of this operation displaying unit (display control, input reception control and the like) are done by the CPU 121 provided in the operation display control unit 102 (will be described later).

FIG. 2 is a block diagram showing a structure relating to control of the image forming apparatus 100 shown in FIG. 1. As shown in FIG. 2, in the structure relating to control of the image forming apparatus 100 in the present embodiment, provided are a whole control unit 101 and an operation display control unit 102. Here, needless to say, it is also possible to have a control unit for controlling an operation of a predetermined part of the image forming apparatus 100 in addition.

The whole control unit 101 performs a control which is necessary for image reading, image formation and various image processes by the image forming apparatus 100. The whole control unit 101 comprises a peripheral circuit 103 which comprises a CPU 104 for performing such control, various circuits such as an I/O circuit, a memory and the like that are necessary for the operation of the CPU 104, an electric power shutoff unit 105 and a DRAM 108 for storing various types of data, the electric power shutoff unit 105 comprising a logic circuit 106 and a regulator 107.

The operation display control unit 102 comprises an LCD 122 which is an unification of a displaying unit for displaying information to a user and an inputting unit for accepting an input from a user, the LCD 122 adopting a touch panel system, an LED 123 for giving a user a notification or the like, ten keys 124, which comprise stationary buttons, for accepting an input from a user, a sub power switch 125 which is provided separately from a main power switch of the image forming apparatus 100, and a CPU 121 for controlling an operation of each circuit included in the operation display control unit 102.

Further, the CPU 121 performs a process control (will be described later) according to a detection result from a platen cover open-close detecting sensor 126 for detecting whether a platen cover (it is integrated with an automatic document conveyance unit 1 in FIG. 1) which covers a document platform of the image reading unit 2 of the image forming apparatus 100 is open or close, the platen cover open-close detecting sensor 126 being provided outside of the operation display control unit 102. In combination with the LCD 122, the ten keys 124, the sub power switch 125 and the platen cover open-close detecting sensor 126, the CPU 121 constitutes the reception section for accepting a user operation regarding use of the image forming apparatus 100.

Further, as shown in FIG. 2, a DC power source 130 supplies voltage of 5V to the DRAM 108, the operation display control unit 102 and the electric power shutoff unit 105. The regulator 107 of the electric power shutoff unit 105 steps down the voltage of 5V from the DC power supply 130 to 3V, to supply the 3V voltage to the peripheral circuit 103.

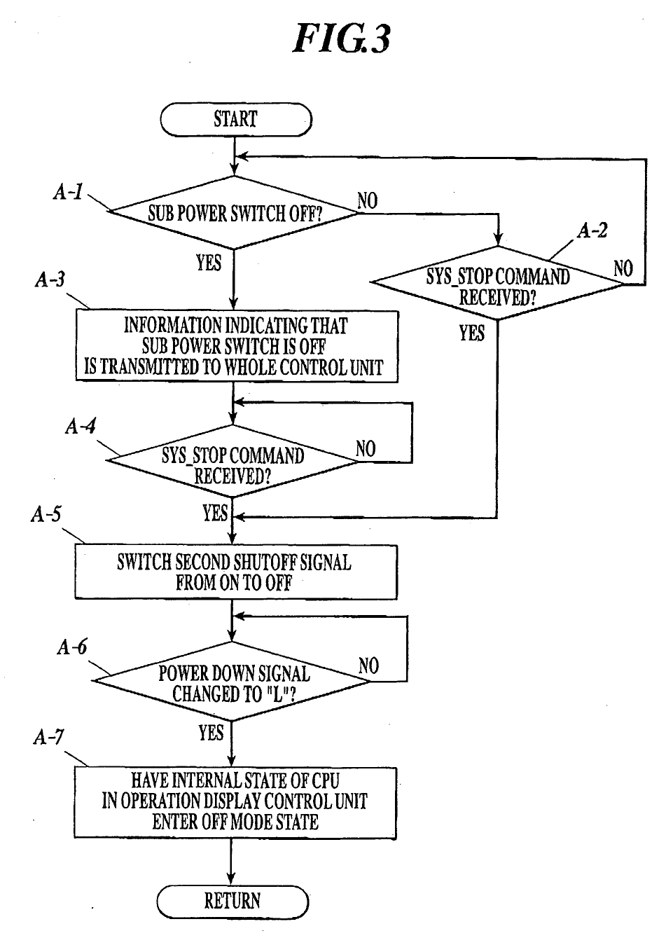

FIG. 3 is a flowchart illustrating a processing operation by the CPU 121 provided in the operation displaying control unit 102, which is carried out when the image forming apparatus 100 is shifted to a power saving mode.

As shown in FIG. 3, the CPU 121 detects whether a user has turned off the sub power switch 125 (step A-1). The sub power switch 125 is a switch which a user actively operates in order to put the image forming apparatus 100 under a power saving mode. With the sub power switch 125 turned off by a user, a process operation which puts the image forming apparatus 100 under a power saving mode is performed (will be described later).

Further, here, a switch performing such function is called the sub power switch. However, for example, with a switch called “power saving switch” provided, when this power saving switch is turned on by a user, the image forming apparatus is shifted to a power saving mode. Such switch is also applicable to the present embodiment.

If the sub power switch 125 is not set OFF in Step A-1, whether a SYS_STOP command which is transmitted from the whole control unit 101 through a serial I/F at a timing (will be described later) is received is judged (Step A-2). If there is not such reception, the operation goes back to Step A-1 to repeat the above-described processes.

If the sub power switch 125 is turned off (OFF) in Step A-1, information indicating that the sub power switch 125 is turned off is transmitted to the whole control unit 101 through the serial I/F (Step A-3). Thereafter, the SYS_STOP command which is transmitted from the whole control unit 101 through the serial I/F is awaited (Step A-4).

If the SYS_STOP command is received in Step A-2 or in Step A-4, a second shutoff signal which is a signal from the CPU 121 to the logic circuit 106 is switched from a signal level “H” (which means ON, a logic indicating electric power being supplied) to a signal level “L” (which means OFF, a logic indicating shutoff) (Step A-5).

In other words, the operation display control unit 102 does not switch the second shutoff signal to a logic indicating shutoff until the whole control unit 101 transmits the SYS_STOP command (instruction) through the serial I/F.

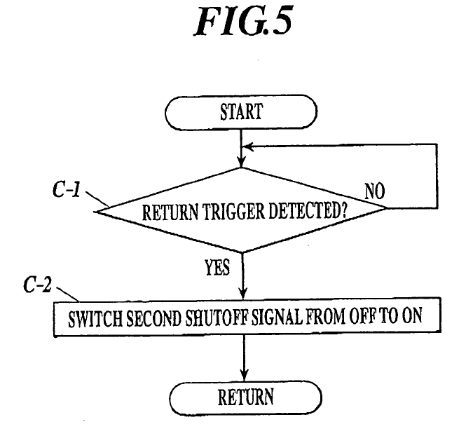

Thereafter, the CPU 121 waits until a power down signal which is a signal from the peripheral circuit 103 to the CPU 121 is switched from the signal level “H” (which means that the peripheral circuit 103 is being supplied with electric power and is under a normal operation) to the signal level “L” (which means that the peripheral circuit 103 is halted from the electric power supply and is under a sleep mode) (Step A-5). If the power down signal is switched to the signal level “L”, the CPU 121 judges that the image forming apparatus 100 has been shifted to the power saving mode and the electric power supply to a predetermined circuit and the like has been halted. Then, the CPU 121 enters an OFF mode state (Step A-7). The OFF mode state is to see whether a return trigger which makes the image forming apparatus 100 return from the power saving mode to a normal mode (a mode under which it is possible to provide a user with each function of the image forming apparatus) is generated. Description regarding the return trigger will be made later with reference to FIG. 5.

By the way, as shown in FIG. 3, the CPU 121 does not execute the process of Step A-7 until the power down signal is switched to the signal level “L” in Step A-6, that is, a detection process of the return trigger for returning from the power saving mode to the normal mode. This is because the performance of the CPU 104 would become unstable if the image forming apparatus 100 are returned from the power saving mode before the CPU 104 of the whole control unit 101 is completely stopped.

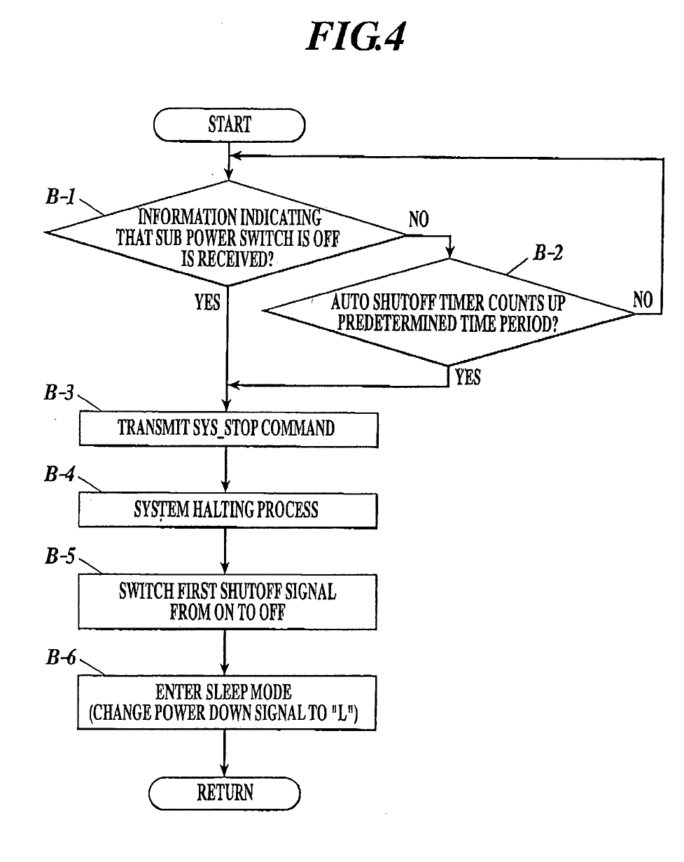

Next, with reference to FIG. 4, a processing operation at the side of the whole control unit 101 will be described.

FIG. 4 is a flowchart illustrating a processing operation by the CPU 104 provided in the whole control unit 101, which is carried out when the image forming apparatus 100 of the present embodiment is shifted to the power saving mode.

As shown in FIG. 4, the CPU 104 judges whether information indicating the sub power switch 125 is turned off (OFF) is received from the CPU 121 through the serial I/F (Step B-1). If such information is not received, the CPU 104 judges whether an auto shutoff timer counts up a predetermined time period (Step B-2). If such time period has not yet been counted up, the operation goes back to Step (Step B-1) to repeat the above-described processes.

For example, the auto shutoff timer is a timer which counts up a time period during which a user is not using the image forming apparatus 100 and predetermined operations (reading a document, forming an image, applying various image processes and the like) are halted, and when this timer counts up the time period, the image forming apparatus 100 is shifted to the power saving mode. This timer value may be optionally set or changed by a user, a maintenance staff or the like, or may be predetermined.

If the information indicating that the sub power switch 125 is turned off is received in Step B-1, or if the auto shutoff timer is counted up in Step B-2, the SYS_STOP command is transmitted to the CPU 121 through the serial I/F (Step B-3).

Thereafter, the CPU 104 executes a system halting process (Step B-4). The system halting process is a process which is executed as the power saving mode in a conventional image forming apparatus. For example, the system halting process controls temperature of a heater 38c of the fixing device 38 to be lower than temperature which is necessary when an image is formed, stops the electric power supply to the heater 38c, and controls the electric power supply to each of other circuits, in order to reduce electric power consumption.

Thereafter, the CPU 104 switches the first shutoff signal, which is a signal to the logic circuit 106, from the signal level “H” (which means ON, a logic indicating electric power being supplied) to the signal level “L” (which means OFF, a logic indicating shutoff) (Step B-5), and switches the power down signal, which is a signal from the peripheral circuit 103 to the CPU 121, from the signal level “H” (which means that the electric power is being supplied to the peripheral circuit 103 and the peripheral circuit 103 is under a normal operation) to the signal level “L” (which means that the electric power supply to the peripheral circuit 103 is halted and the peripheral circuit 103 is under a sleep mode), for entering the sleep mode.

At this time, the logic circuit 106 gives an instruction to the regulator 107 only when both the first shutoff signal and the second shutoff signal are switched to OFF, for shutting off the electric power supply of DC 3V from the regulator 107 to the peripheral circuit 103.

In this way, under the power saving mode, it is possible to save electric power consumption by the peripheral circuit 103, and thereby it is possible to reduce electric power consumption more than conventional arts.

Next, with reference to FIG. 5, a processing operation as to when the image forming apparatus 100 returns from the power saving mode to the normal mode will be described.

FIG. 5 is a flowchart illustrating a processing operation as to when the image forming apparatus 100 of the present embodiment is returned to a normal mode from the power saving mode.

In the power saving mode, as described above, the CPU 104 is under the sleep mode. Therefore, the CPU 121 takes charge of the return from the power saving mode to the normal mode.

As shown in FIG. 5, the CPU 121 perpetually sees whether a return trigger is detected or not (Step C-1). As the return trigger, for example, a detection by a platen cover open-close detecting sensor 126 regarding whether a platen cover is opened or closed can be one. In addition, what can be cited as the return trigger is, a detection by a sensor (not shown) in regard to whether a document is put on the document feeding platform 11, an operation by a user on the LCD 122, an operation by a user at the numeric keys 124, an operation by a user at the sub power switch 125, or the like. Each of them is a detection of an operation or an action for a user to use the image forming apparatus 100.

If the CPU 121 detects the return trigger in Step C-1, the CPU 121 switches the second shutoff signal, which is a signal from the CPU 121 to the logic circuit 106, from the signal level “L” (which means OFF) to the signal level “H” (which means ON) (Step C-2).

In response to this switching, since the second shutoff signal is turned “H” (which means ON), the logic circuit 106 gives an instruction to the regulator 107 so as to resume the electric power supply of DC 3V from the regulator 107 to the peripheral circuit 103.

When the electric power supply is resumed in this way, the CPU 104 gets waken up to be in an operating state. Then, as well as the general case of the time of being powered on, the CPU 104 starts controlling the whole image forming apparatus 100.

The entire disclosure of a Japanese Patent Application No. Tokugan 2004-073729 filed on Mar. 16, 2004, including specifications, claims, drawings and summaries are incorporated herein by reference in their entirety.

1. An image forming apparatus comprising:
an image reading section for obtaining image data by reading an image from a document;
an image forming section for forming an image on a sheet based on the image data;
a reception section for accepting a user operation regarding use of the image forming apparatus; and
a whole control section for controlling an operation of the image reading section and an operation of the image forming section,
wherein the image forming apparatus has a normal mode under which an operation of the image forming apparatus is provided, and a power saving mode under which electric power consumption of the image forming apparatus is reduced, and
wherein the whole control section is in a non-operating state under the power saving mode, and is set to be in an operating state when the reception section accepts the user operation.

2. The apparatus of claim 1, further comprising:
an electric power shutoff section for putting the whole control unit in the non-operating state by shutting off an electric power supply to the whole control unit,
wherein the electric power shutoff section shuts off the electric power supply to the whole control unit based on a first shutoff signal from the whole control section and a second shutoff signal from the reception section when both the first shutoff signal and the second shutoff signal indicate shutoff.

3. The apparatus of claim 1, wherein, under the power saving mode, the reception section accepts the user operation and returns the image forming apparatus to the normal mode.

4. The apparatus of claim 2, wherein, when the reception section accepts the user operation under the power saving mode, the reception section switches the second shutoff signal to a signal indicating that electric power is supplied.

5. The apparatus of claim 4, wherein, after the image forming apparatus is shifted to the power saving mode from the normal mode and the reception section receives a power down signal from the whole control section, the reception section accepts the user operation.

6. The apparatus of claim 2, wherein the reception section switches the second shutoff signal to a signal indicating shutoff only based on a command from the whole control section.

7. An image forming apparatus comprising:
an image reading section for obtaining image data by reading an image from a document;
an image forming section for forming the image on a sheet based on the image data; and
a whole control section for controlling an operation of the image reading section and an operation of the image forming section,
wherein a mode of the image forming apparatus is switchable between a normal mode under which an operation of the image forming apparatus can be provided and a power saving mode under which electric power consumption of the image forming apparatus is reduced, and
wherein the image forming apparatus performs switching of the whole control unit from an operating state to a non-operating state when being shifted to the power saving mode from the normal mode, and image forming apparatus is not returned to the normal mode from the power saving mode until the switching is completed.

8. The apparatus of claim 7, further comprising an electric power shutoff section for putting the whole control section in the non-operating state by shutting off an electric power supply to the whole control section.

9. The apparatus of claim 7, further comprising a reception section for accepting a user operation regarding use of the image forming apparatus,
wherein, under the power saving mode, the reception section accepts the user operation and returns the image forming apparatus to the normal mode.

10. The apparatus of claim 7, wherein the apparatus detects a return trigger for returning from the power saving mode to the normal mode after the switching is completed.
